(19) United States
(12) Patent Application Publication
(10) Pub. No.: US 2003/0232598 A1
(43) Pub. Date: Dec. 18, 2003

(54) Method and apparatus for intrusion management in a wireless network using physical location determination

(76) Inventors: Daniel Aljadeff, Kiriat Ono (IL); Yuval Bar-Gil, Walnut Creek, CA (US); Michael Robert Overy, Medstead (GB); Michael James Sullivan, Belmont, CA (US)

Correspondence Address: WEISS & MOY PC, 4204 NORTH BROWN AVENUE, SCOTTSDALE, AZ, 85251, US

(21) Appl. No.: 10/171,427

(22) Filed: Jun. 13, 2002

(51) Int. Cl. H04L 9/00

(52) U.S. Cl. 455/41.2; 455/456.1; 455/41.1; 455/432.1; 455/404.2

(57) ABSTRACT

A method and apparatus for intrusion management in a wireless network uses distance measurement or location finding techniques to permit an administrator to manage security within a wireless network. A distance measurement or location-finding is performed between devices by transmitting and receiving one or more signals and computing an indication of physical location of a device attempting to connect or communicating within a wireless network. The resulting computed distance or location can be used to alert an administrator, provide a map of connected devices and/or automatically disconnect one or more suspect devices. Alternatively or in combination, changes in received signal amplitudes, time delays and/or other signal characteristics can be used to detect changes in the network due to intrusions.

### CROSS-REFERENCE TO RELATED APPLICATIONS

The present application is related to previously-filed United States Patent Applications assigned to the same assignee: “DISTANCE MEASURING METHOD AND APPARATUS USING RF MODULATED ELECTROMAGNETIC WAVES IN WIRELESS APPLICATIONS”, Ser. No. 09/548,732, filed Apr. 13, 2000; “ACCURATE DISTANCE MEASUREMENT USING RF TECHNIQUES”, Ser. No. 09/759,601 filed Jan. 16, 2001; “SYSTEM AND METHOD FOR REDUCING MULTIPATH DISTORTION IN WIRELESS DISTANCE MEASUREMENT SYSTEMS”, Ser. No. 09/759,600, filed Jan. 16, 2001; “DISTANCE MEASUREMENT USING HALF-DUPLEX RF TECHNIQUES”, Ser. No. 09/759,602, filed Jan. 16, 2001; “METHOD AND SYSTEM FOR DISTANCE MEASUREMENT IN A LOW OR ZERO INTERMEDIATE FREQUENCY HALF-DUPLEX COMMUNICATIONS LOOP”, Ser. No. ______, filed May 2, 2002; and “METHOD AND APPARATUS FOR ENHANCING SECURITY IN A WIRELESS NETWORK USING DISTANCE MEASUREMENT TECHNIQUES”, Ser. No. ______, filed May ______, 2002. The specifications of the above-referenced U.S. Patent Applications are herein incorporated by reference.

### BACKGROUND OF THE INVENTION

1. Field of the Invention

The present invention relates generally to communications networks, and more specifically, to a method and system for monitoring and managing a wireless network by determining the position of wireless devices.

2. Background of the Invention

A multitude of wireless communications systems are in common use today. Mobile telephones, pagers and wireless-connected computing devices such as personal digital assistants (PDAs) and laptop computers provide portable communications at virtually any locality. In particular, BLUETOOTH devices provide a wireless network operating in the 2.4 GHz Industrial Scientific and Medical band (BLUETOOTH is a trademark of Bluetooth SIG, Inc., which is an acronym for Bluetooth Special Interest Group—a consortium of wireless device manufacturers). Wireless local area networks (WLANs) and wireless personal area networks (WPANs) according to the Institute of Electrical and Electronic Engineers (IEEE) specifications 802.11 (WLAN) (including 802.11a, 802.11b, etc.), 802.15.1 (WPAN) and 802.15.4 (WPAN-LR) also provide wireless interconnection of computing devices and personal communications devices, as well as other devices such as home automation devices.

Within the above-listed networks and wireless networks in general, intrusion detection is increasingly necessary as devices connected to such wireless networks control critical systems, funds transactions and may contain and exchange confidential information. Wireless networks generally fall within one of two categories: “ad-hoc networks” or “infrastructure networks”. Ad-hoc wireless networking permits spontaneous connection of devices with no previous connection relationship. Devices may enter the range of the wireless network and thereby spontaneously connect to other devices. Pre-configured infrastructure wireless networks typically permit connection of only authorized devices that are part of the infrastructure known by information stored in a database during network configuration.

A particular problem in wireless networks is the presence of unauthorized or “rogue” access points. An access point is a device that can connect other wireless devices to the network. A rogue access point is typically attached to the wireless network by either an authorized user of the network or by an unauthorized person. The rogue is typically set-up in violation of network policy, e.g., without proper authentication requirements for connection to other devices, direct logical connection to the network such as coupling into a specific switch port, connection to virtual private network (VPN) gateways or bridges and other configurations that are not consistent with maintaining security within a network. The rogue access point leaves (or purposely generates) a security hole in the network in that other device can connect to the network via the rogue access point. A network administrator may notice the presence or improper configuration of the device, but may be unable to find it. Or, the network administrator may notice the actions or connections of other devices connecting through the rogue device and be unable to determine either the existence or location of the rogue device.

Security in a traditional (wired) infrastructure LAN has been easier to maintain than in a WLAN, since physical cabling to the network is required for communications with other devices on the network, thus requiring physical entry into the facility to make a network connection or through limited connection points exposed through a Wide Area Network. Detecting an unauthorized wireless device that has connected to the network is difficult or impossible, as the unauthorized device may be impersonating a known device based on information received by receiving signals exchanged between the impersonated device and the network. Further, “man-in-the-middle attacks” may be used to connect a known wireless device to a wireless network by one or more devices acting as a go-between, receiving signals from the known device and relaying them (possibly with modification or deletion of some communications) to a wireless network node and intercepting return signals that may also be modified or deleted.

Further, ad-hoc connection of unknown devices to wireless networks is desirable in many applications, such as automated teller machine (ATM) connections for transactions with a wireless payment or ticketing device or a personal computing device. Although transactions might require supplemental authentication such as identification, it is desirable to eliminate the need for these additional authentication measures, or provide further verification measures to the person visually identifying a network user. It is also desirable to create a secure link between the client and an ATM to ensure that sensitive information, including authentication information, is not compromised. Improving security of the above-described link is especially desirable when there is a “spontaneous” connection between two devices having no prior connection relationship.

Therefore, it would be desirable to provide a method of managing a wireless network and a wireless networking system wherein intrusions can be detected, identified and eliminated.

### SUMMARY OF THE INVENTION

The above objectives of detecting, identifying and eliminating intrusions in wireless networks are achieved in a method and system. The method is embodied in a system that determines a physical location of a first wireless device coupled to the network by computing characteristics of signals received from the first wireless device by one or more other wireless devices. The system and method then provide a mechanism for determining whether or not the wireless device connection is an intrusion or presents a security threat of potential future intrusion. The method and system may display location information for the wireless device and/or issue an alarm or an alert to a network administrator, or may automatically disconnect the wireless device if it is determined to be an intruding device.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting a wireless network in which embodiments of the invention may be practiced.

FIG. 2 is a block diagram depicting a communications network within which embodiments of the present invention may be practiced.

FIG. 3 is a pictorial diagram depicting a graphical output of a software application in accordance with an embodiment of the invention.

FIG. 4 is a pictorial diagram depicting a graphical output of a software application in accordance with an alternative embodiment of the invention.

### DETAILED DESCRIPTION OF THE PREFERRED EMBODIMENTS

The present invention provides intrusion detection within a wireless network such as a WLAN (e.g., IEEE 802.11) or WPAN network (e.g., as BLUETOOTH) network, by determining physical locations of devices connected to the wireless network. Intrusion as used in the context of the present invention refers to an electronic connection or attempted connection to a wireless network, and may include physical intrusion of a facility with an unauthorized wireless device, or may occur by connection to a device outside of a physical facility.

Wireless network devices may be enhanced to provide a measurement of the location or distance between connected devices without adding a separate infrastructure, thereby providing position determination or distance measurement with low incremental cost. Alternatively, a separate infrastructure may be added for providing device location information, avoiding the need to replace installed devices or otherwise reconfigure the wireless network. Ultra Wideband (UWB) technologies as proposed by the UWB working group includes precision measurement of pulse arrivals, allowing direct distance measurement information (or location estimation using multiple receivers) that may be used in conjunction with the present invention to provide verification of physical location of a connecting device. Since the pulse arrival timing forms part of the communications reception structure, addition of distance measurement may be performed without adding device or complexity or communications overhead and some proposed UWB devices include distance measurement capability.

Specifically, there are three types of intrusions of particular interest. In the first, an intruding device possibly with a high gain antenna, is outside of a predetermined network facility. The device may be using a fake address and/or name matching that of an installed infrastructure device or may be connecting in an ad-hoc fashion. Legitimate users within the facility may wrongly connect to the fake device compromising security. In any of these cases, connection outside of the network facility is undesirable and can be detected or eliminated using techniques in accordance with embodiments of the present invention. Also, legitimate third party devices located outside the facility will sometimes provide wireless coverage overlapping parts of the facility, however this should not pose a security threat and can be distinguished from potential threats using techniques in accordance with embodiments of the present invention.

In the second and third intrusion types, the intruding device is within the predetermined network facility. The second intrusion type is that of the “innocent” intrusion generally perpetrated by an employee who upgrades a non-wireless device to a wireless device, for example by installing a wireless LAN card into a workstation or laptop computer. The second type of intrusion may also be detected or eliminated using techniques in accordance with embodiments of the present invention, and if the intruding device is connected to a “wired” network, action may be taken through the wired network to shut down the intruding access point, or the device may be “blacklisted” from communication with other access points by informing other access points via the wired or wireless network. The blacklisting technique is particularly useful for blocking access to devices that might otherwise not block communications, such as workstation printers or pooled network printers.

In the third intrusion type, the intruding device is within the predetermined network facility, but the device is located in an unexpected place. For example, a visitor or intruder to a facility may attempt to connect to or impersonate a wireless LAN in a hallway or a bathroom using a portable access point in order to retrieve files from a companies database or perform some other unauthorized access. The third type of intrusion may also be detected or eliminated using techniques in accordance with embodiments of the present invention.

As described in the above-incorporated patent applications, the portable devices as well as other communication systems may be enhanced to provide distance measurement capability within portable or stationary wireless devices. The techniques described in the above-incorporated patents introduce distance measurement capability within transceivers that are synchronized or unsynchronized and full-duplex or half-duplex.

Another location estimation technique is Location Finding (LF), in one form of which multiple receivers are used to calculate the time-difference-of-arrival (TDOA) of signals received from a transmitting source. The location of the transmitting source can be determined by triangulation based on the timing between the signal arrivals at the multiple receivers. Angle of arrival methods (AOA) may also be used to locate a unit by intersecting the line of position from each of the receivers. LF and other techniques are well known in the art for providing wireless device location information and may be used within the method and system of the present invention to provide the location information on which the security models of the present invention use to verify the desirability of providing a network connection to a wireless device. Another LF technique that may be used to determine physical location of a wireless device is correlation of received signal strength indication (RSSI) between multiple receivers.

The above-incorporated patent application “METHOD AND APPARATUS FOR ENHANCING SECURITY IN A WIRELESS NETWORK USING DISTANCE MEASUREMENT TECHNIQUES” describes a system that uses physical location information to evaluate and control a pairing or connection process for a wireless device connecting to a wireless network, and for verifying subsequent connections with the wireless network. The present invention concerns monitoring a wireless network to detect unauthorized devices that are connected to the network, providing a complement to the system described in the above-referenced patent application that may be used in conjunction therewith.

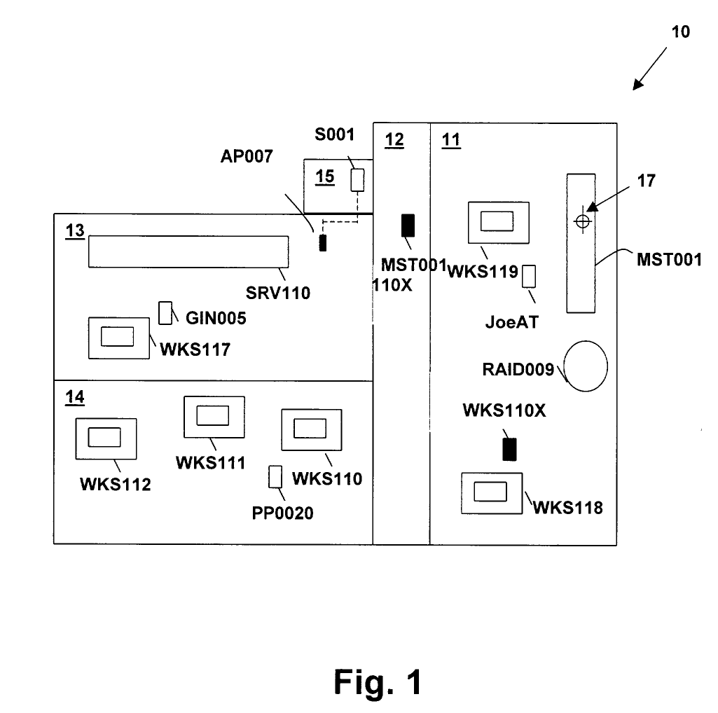

Referring now to the figures and in particular to FIG. 1, a wireless network 10 within which the present invention is embodied is depicted in a pictorial diagram. A plurality of wireless devices: workstations WKS110-112, WKS 117-119, mobile phones GIN005 and JOEAT, server SRV110, laptop computer PP0020, raid array RAID009, and unauthorized mobile phone SRV110X and unauthorized laptop computer WKS110X may inter-communicate via radio-frequency (RF) signals. Mobile phone SRV110X is identifying itself as server SRV110 and has the complete access identification to pose as server SRV110, but is in a different physical location (hallway 12). Laptop computer WKS110X is impersonating workstation WKS110 and was put in place by the user of workstation WKS118, who is an authorized user of the network, but wants to download files that the laptop computers are not permitted to access. Either of the unauthorized devices SRV110X and WKS110X should be disconnected from the system, but are indistinguishable from their authorized counterparts SRV110 and WKS110 by a typical wireless network. However, the physical location of SRV110X and WKS110X can be determined by measuring time difference (or angle) of arrival of their signals to other devices within wireless network 10, or by measuring their communications loop delay to a network master device MST001, or by comparing their relative signal strength (RSSI) or other signal characteristics at other receivers within wireless network 10 or by a combination of any of the above-listed techniques. The RSSI, TDOA and AOA techniques can also be implemented with non-network devices coupled to a monitoring system, as they are “passive systems” in that the techniques only require reception of the signals transmitted by the devices being located.

A rogue access point AP007 is shown connected via Ethernet cable to switch/router S001. Rogue access point AP007 may be configured to permit external wireless devices to couple to a wired network via the switch/router or may provide a wireless connection for unauthorized devices to wireless network 10.

Some embodiments of the invention use a measured distance between devices to determine whether or not the measured distance between devices conforms to a pre-programmed distance (determined at installation for non-mobile devices) or to permit manual/visual verification of a measured distance between a connected device and a reference point 17 (in this case the location of an antenna coupled to network master device MST001). A security perimeter can also be used to estimate whether or not a connected device is within the facility, and if LF techniques are used, whether the wireless device is in a particular room or facility. The security perimeter may be a circular area determined by distance measurement techniques or a specific facility map as provide using location finding techniques.

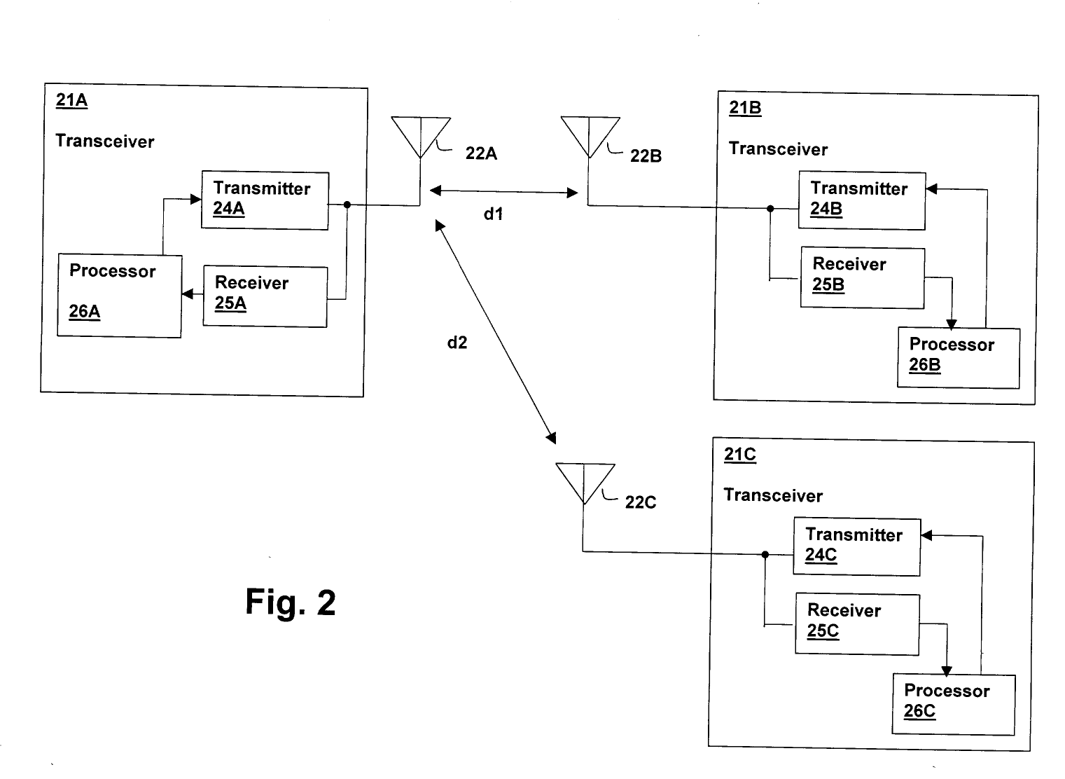

Referring now to FIG. 2, a connection of wireless network devices within which the present invention is embodied are depicted in a block diagram. Wireless devices 21A, 21B and 21C may be mobile telephones, personal digital assistants (PDAs), headsets, laptop computers with wireless modems, pagers, or other portable or non-portable network devices that include wireless communications capability. Wireless devices 21B and 21C may alternatively be receive-only devices monitoring communications between wireless device 21A and some other wireless network device. Some devices in the associated wireless network may be receive-only or broadcast only, but in order to use distance measuring techniques, a pair of transceivers is used, as a signal must be transmitted from an initiating device to a responding device and a second signal is then returned from the measured device. Location finding techniques may be performed on transmit-only devices by observing the TDOA between other receivers when the transmit-only device transmits. For transmit only devices, secure key exchange protocols are not possible, so location finding techniques are especially important to enhance security if a transmit-only device is permitted to introduce information to a wireless network.

Wireless devices 21A-21C are generally transceivers capable of communicating using a common protocol and frequency band of operation. For example, transceivers 21A-21C may be BLUETOOTH devices communicating in a band centered around 2.4 GHz and having a bandwidth of approximately 80 MHz. 79 channels are provided with a 1 MHz bandwidth each, and the devices frequency hop at a rate of 1600 hops per second. A complete protocol, including communications control protocols and transport layer protocols are defined by the BLUETOOTH specification, providing a complete wireless networking solution. While the BLUETOOTH specification is of particular interest in wireless networking, it should be understood that the techniques of the present invention apply to wireless networks in general.

Each of transceivers 21A-21C include a transmitter 24A-24C, a receiver 25A-25C an antenna 22A-22C and a processor 26A-26C, processors 26A-26C include necessary memory such as RAM or ROM for storing program instructions and data for execution on a microcontroller, microprocessor or a general purpose computer system for implementing methods in accordance with embodiments of the present invention. For example, transceiver 21A may be a wireless network server node comprising a wireless modem coupled to a server having random access memory (RAM) and disk storage for storing, retrieving and executing a network management application having a database of infrastructure connected wireless devices, including a database of pre-programmed distances for comparison to measured distances in accordance with an embodiment of the present invention. Transceiver 21B may be a PDA connected to a server through transceiver 21A and transceiver 21C may be a headset connecting to transceiver 21C.

Any of transceivers 21A-21C may initiate a location finding process, and in some applications all of the network devices that have distance measuring or location finding capability will be used to provide a device location map with a high degree of accuracy. For distance measuring, determination of a loop delay between transceiver 21A and 21B, by processor 26A can estimate the distance to PDA transceiver 21B and determine whether or not the PDA transceiver 21B is an authorized connection. If the distance indicates that PDA transceiver 21B is an undesirable connection, network communications between PDA transceiver)21B and the rest of the network can be terminated, or a network administrator can be notified that PDA transceiver 21B is a suspect connection.

For location finding, distances d1 and d2 can be used to determine the location of transceiver 21B for signals transmitted by transceiver 21B as received by transceivers 21A and 21C. The location of transceiver 21B can be determined geometrically by triangulating distances d1 and d2. In another embodiment, in which transceiver 21B has no distance measurement capability, the TDOA of a signal transmitted by transceiver 21B and received by transceivers 21A and 21C is used to determine whether unit 21B is located on an expected line of position. Alternatively, an RSSI profile can be used to estimate distances d1 and d2 by measuring relative signal strengths for signals transmitted by transceiver 21B as received by transceivers 21A and 21C.

Transceivers 21A and/or 21C may verify that information provided by transceiver 21B corresponds to a known device and processor 26A or 26C (or some other processor coupled to transceivers 21A and 21C) may verify that the distance 21B corresponds to an expected distance for transceiver 21B based on stored distance or location information.

It is not necessary to determine absolute location or distance in order to manage a network in accordance with embodiments of the present invention. Changes in network configuration can be detected using the above-described techniques, a change in RSSI profile (signal strength as received at one or more devices) or transmission/reception delay between one ore more devices can be used to trigger an alert event. The measurements can be repeated over long periods of time and processed to minimize false alarms.

The present invention may measure distance using techniques similar to those described in the above-incorporated patent applications. In the above-incorporated patent applications, the slope of phase versus frequency as measured around a communications loop and over a plurality of frequencies is used to determine the distance between a pair of transceivers. The ambiguities due to an unknown number of wavelengths between the transceivers and due to multipath distortion are resolved by the use of multiple frequency measurements. The above multi-transmission scheme applies also to RSSI profile measurements, but with no ambiguities and with compensations for gain variations with frequency, if necessary. For illustrative purposes, the description of the technique includes receiving and transmitting a single signal, but should be understood to contemplate multiple discrete frequency measurements or a continuously varying measurement. With respect to LF techniques, a single frequency or multiple frequencies may be used, depending on the number of receivers and the LF technique used to determine the location. Further security can be provided by encrypting/decrypting the distance measurement or location finding signals.

The results of the measurements described above are either used to automatically terminate connections based on their physical locations, or may be used to provide a graphical, audible or other alert to a network administrator. Additionally, detection of such an unauthorized device may automatically result in notifications to other devices (blacklisting) via the wireless network or wired connections. The actions taken upon notification may include restricting the types of communications generated and received by nearby devices, sending alarm messages to nearby devices, etc.

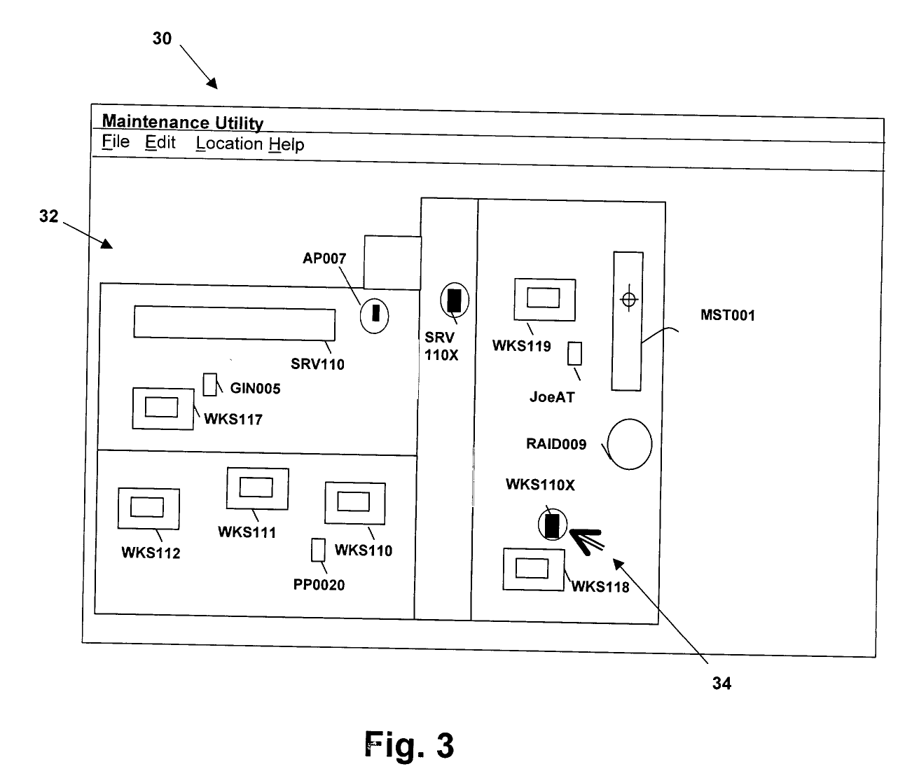

Referring now to FIG. 3, a graphical display in accordance with an embodiment of the present invention is depicted. A map 32 of the facility shown in FIG. 1 is displayed within a display window 30 of a software application for managing a wireless network in accordance with an embodiment of the present invention. Multiple maps may be used to provide screens for particular rooms, facilities or local networks. The wireless network devices (including the unauthorized devices) are shown on within map 32 and the display may be updated in conformity with the measured physical location indications of the various wireless network devices. Alert indications 33 are shown as circles drawn around icons corresponding to the detected unauthorized wireless devices, but flashing icons, contrasting colors and other attention-getting mechanisms may be used to mark the detected unauthorized devices.

A pointer 34 (or other suitable input mechanism) may be used to terminate the connection to a device (or only the unauthorized devices) by positioning pointer 34 at the icon corresponding to an unauthorized device and pressing a button, activating a pop-up menu or other mechanism for activating the connection termination process. The use of a graphical display to permit a network administrator or user to manage a wireless network is especially useful in organizing a large wireless network wherein hundreds of wireless devices may be “seen” by the network.

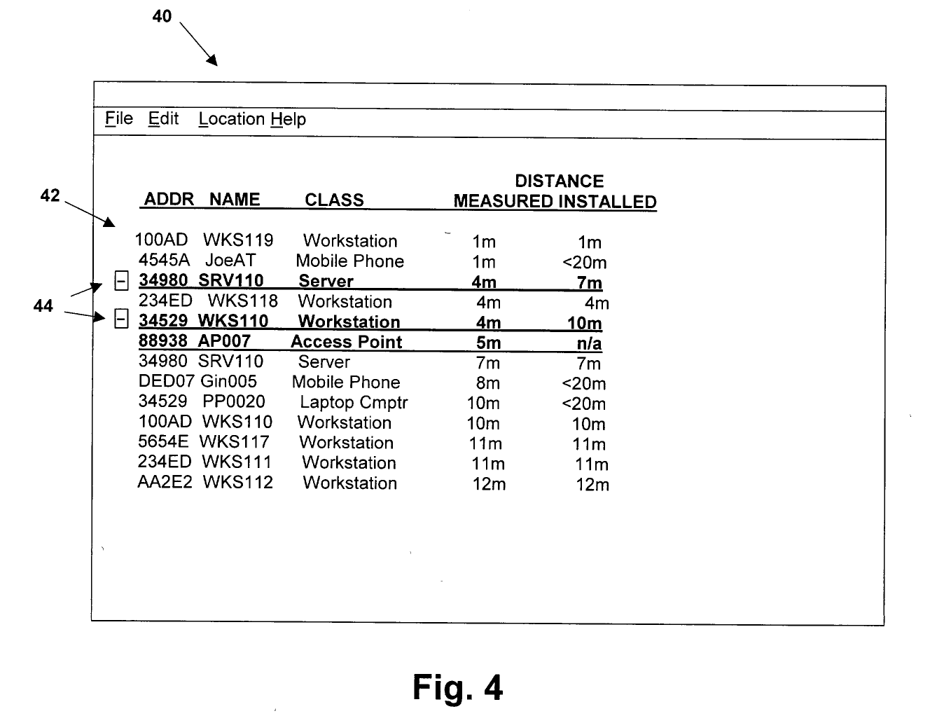

Referring now to FIG. 4 a graphical output 40 of a network management application is depicted in accordance with an alternative embodiment of the invention. Graphical output 40 displays a list 42 of devices that may be organized in order of increasing distance from a wireless server connection point making it easier to view desired local devices and ignore more remote devices that might not be unconnected. The list may be segregated into screens for particular rooms, facilities or local networks. List 42 shows address, name, device class, and distance/location information for a plurality of devices.

List 42 depicted in graphical output 40 provides an indication of connections and indicates unauthorized devices such as the two entities representing themselves as SRV110 and WKS 110, rouge device AP007, as well as a distance location for each of the devices. Location information provided by LF may be displayed as coordinates or in a graphical map, permitting verification of device location for connecting devices. Unauthorized connections are shown within the exemplary list 42 by underlining and bold text, but other techniques such as colors and flashing text lines may be used to draw attention to the unauthorized connections. Disconnect buttons 44 are provided in the example to permit disconnection of any unauthorized device by activating the disconnect button 44 adjacent to the list entry for the unauthorized device.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for managing a wireless network, comprising:
receiving radio-frequency signals emitted from a first wireless device communicating with said wireless network and at least one other wireless device coupled to said wireless network;
computing an indication of physical location of said first wireless device with respect to said at least one other wireless device in conformity with characteristics of said received signals; and
evaluating a connection between said first wireless device to said wireless network to determine whether or not said connection is undesirable in conformity with said indication of physical location.

2. The method of claim 1, further comprising displaying said indication of physical location to an administrator, and wherein said evaluating is performed by said administrator in conformity with said displayed indication of physical location.

3. The method of claim 2, further comprising:
receiving a user input from said administrator for disconnecting said first wireless device in response to said displaying; and
in response to said user input, disconnecting said first wireless device from said wireless network.

4. The method of claim 1, wherein said wireless device is connected to said wireless network, and wherein said method further comprises automatically disconnecting said first wireless device in response to said evaluating determining that said connection is undesirable.

5. The method of claim 1, wherein said first wireless device is connected to said wireless network, and wherein said method further comprises communicating an alert to other wireless devices coupled to said wireless network.

6. The method of claim 6, wherein said method further comprises in response to said other wireless devices receiving said alert, restricting communications within said wireless network.

7. The method of claim 6, wherein said method further comprises in response to said other wireless devices receiving said alert, generating a local warning on at least one of said other wireless devices.

8. The method of claim 1, and wherein said method further comprises generating an alert to a network administrator in response to said evaluating determining that said connection is undesirable.

9. The method of claim 1, wherein said method further comprises generating a graphical display of said wireless network configuration, whereby information associated with said first wireless device including results of said evaluating and said computing are displayed to an administrator.

10. The method of claim 9, wherein said graphical display is a graphical map of a network facility, whereby physical location of said first wireless device is displayed on said graphical map.

11. The method of claim 9, wherein physical location of said first wireless device is displayed in conformity with said indication of physical location, whereby said graphical map is updated to reflect a current position of said first wireless device.

12. The method of claim 9, wherein said graphical display is a list of other wireless devices connected to said network and said wireless device, wherein a list item corresponding to said wireless device includes said indication of physical location and an indication that said connection is undesirable.

13. The method of claim 9, further comprising a user input mechanism for disconnecting said wireless device from said wireless network associated with said associated wireless device and evaluating and computing results information.

14. The method of claim 1, further comprising detecting a change in topology of said wireless network, and wherein said measuring, computing and evaluating are performed in response to said detecting.

15. The method of claim 14, wherein said wireless device is a device connected to said wireless network and said detecting detects that said indication of physical location has changed.

16. The method of claim 1, further comprising determining whether or not said wireless' device is within a security perimeter, and wherein said evaluating is performed selectively in response to whether or not said wireless device is within said security perimeter.

17. The method of claim 1, further comprising transmitting a distance measuring signal from said at least one other wireless device to said first wireless device, wherein said receiving receives a response from said first wireless device to said distance measuring signal, and wherein said computing computes a distance between said first wireless device and said at least one other wireless device in conformity with a communications time delay between said transmitting and said receiving.

18. The method of claim 17, wherein said first wireless device does not generate a response to said distance measuring signal, wherein said received response is a null response, and wherein said evaluating evaluates said connection as undesirable.

19. The method of claim 1, wherein said at least one other wireless device comprises multiple wireless devices, wherein said receiving receives signals from said first wireless device at said multiple wireless devices, and wherein said computing computes a location of said first wireless device in conformity with communications time delay differences between receipt of said signals at said multiple wireless devices, whereby position of said first wireless device is triangulated from said time delay differences.

20. The method of claim 19, wherein said at least one other wireless device comprises two wireless devices, wherein said receiving receives signals from said first wireless device at said two wireless devices, and wherein said computing computes a location curve intersecting a location of said first wireless device in conformity with communications time delay differences between receipt of said signals at said multiple wireless devices, whereby position of said first wireless device is determined as lying on said curve.

21. The method of claim 1, wherein said at least one other wireless device comprises multiple wireless devices, wherein said receiving receives signals from said first wireless device at said multiple wireless devices, and wherein said computing computes a location of said first wireless device in conformity with differences in signal strengths of said received signals.

22. A wireless network, comprising:
a first wireless communications device coupled to said wireless network;
at least one other wireless communications device coupled to said wireless network, and wherein said at least one other wireless communications device comprises
a measurement sub-system for measuring characteristics of signals received at said at least one other wireless device;
a processing sub-system for computing an indication of a physical location of said first wireless device in conformity with said measured characteristics; and
a security sub-system for evaluating a connection between said first wireless device and said wireless network to determine that said connection is undesirable in conformity with said indication of physical location.

23. The wireless network of claim 22, further comprising a graphical display for displaying said indication of physical location to an administrator, and wherein said evaluating is performed by said administrator in conformity with said displayed indication of physical location.

24. The wireless network of claim 23, further comprising a user input device for receiving a user input from said administrator for disconnecting said first wireless device in response to said displaying, and wherein said security subsystem disconnects said first wireless device from said wireless network in response to said user input.

25. The wireless network of claim 22, wherein said security subsystem automatically disconnects said first wireless device in response to said evaluating determining that said connection is undesirable.

26. The wireless network of claim 22, wherein said first wireless device is connected to said wireless network, and wherein said security subsystem generates an alert to other wireless devices coupled to said wireless network.

27. The wireless network of claim 26, wherein said security subsystem further communicates an alert for restricting communications within said wireless network.

28. The wireless network of claim 22, wherein said security subsystem generates an alert to a network administrator in response to determining that said connection is undesirable.

29. The wireless network of claim 22, further comprising a graphical display for displaying a configuration of said first wireless network, whereby information associated with said first wireless device including results of said evaluating and said computing are displayed to an administrator.

30. The wireless network of claim 29, wherein said graphical display displays a graphical map of a network facility, whereby physical location of said first wireless device is displayed on said graphical map.

31. The wireless network of claim 30, wherein said physical location of said first wireless device is displayed in conformity with said indication of physical location, whereby said graphical map is updated with a current position of said first wireless device.

32. The wireless network of claim 29, wherein said graphical display displays a list of other wireless devices connected to said network and said wireless device, wherein a list item corresponding to said first wireless device includes said indication of physical location and an indication that said connection is undesirable.

33. The wireless network of claim 29, further comprising a user input device for receiving a user input for disconnecting said first wireless device from said wireless network, said user input associated with said information via a positional link between said graphical display and said user input device.

34. The wireless network of claim 22, wherein said security subsystem further detects a change in topology of said wireless network, and wherein said security subsystem evaluates said connection in response to said detecting.

35. The wireless network of claim 34, wherein said first wireless device is a device connected to said wireless network and said security subsystem detects that said indication of physical location has changed.

36. The wireless network of claim 22, wherein said security subsystem determines whether or not said first wireless device is within a security perimeter, and selectively evaluates desirability of said connection in response to whether or not said first wireless device is within said security perimeter.

37. The wireless network of claim 22, wherein said at least one other wireless device transmits a distance measuring signal and receives a response from said first wireless device to said distance measuring signal, and wherein said measuring subsystem measures a communications time delay from a transmitting said distance measuring signal to a receiving of said response, whereby said processing subsystem computes a distance between said first wireless device and said at least one other wireless device in conformity with said communications time delay.

38. The wireless network of claim 22, wherein said at least one other wireless device comprises multiple wireless devices, and wherein said at least one other wireless device receives signals from said first wireless device, and wherein said measuring subsystem within each at of said multiple wireless devices measures a communications time of receipt of said signals, and wherein said wireless network further comprises a master processor for receiving said measured times of receipt from said multiple wireless devices and computes a location of said first wireless device in conformity with differences between said times of receipt.

39. The wireless network of claim 38, wherein said at least one other wireless device comprises two wireless devices, wherein said processing subsystem computes a location curve intersecting a location of said first wireless device in conformity with communications time delay differences between receipt of said signals at said multiple wireless devices, whereby position of said first wireless device is determined as lying on said curve.

40. The wireless network of claim 22, wherein said at least one other wireless device comprises multiple wireless devices, and wherein said at least one other wireless device receives signals from said first wireless device, and wherein said measuring subsystem within each at of said multiple wireless devices measures a signal strength of said received signals, and wherein said wireless network further comprises a master processor for receiving indications of said amplitude from said multiple wireless devices and computes a location of said first wireless device in conformity with relative strengths of said received signals.

41. A method for managing a wireless network, comprising:
receiving radio-frequency signals emitted from a first wireless device connected to said wireless network and at least one other wireless device coupled to said wireless network;
determining that a characteristic of said received signal deviates from an expected characteristic of said received signal; and
evaluating a connection between said first wireless device to said wireless network to determine that said connection is undesirable in conformity with said determination.

42. The method of claim 41, further comprising transmitting a distance measuring signal from said at least one other wireless device to said first wireless device, wherein said receiving receives a response from said first wireless device to said distance measuring signal, and wherein said determining determines that a communications time delay between said transmitting and said receiving deviates from an expected time delay.

43. The method of claim 41, wherein said receiving receives signals from said first wireless device at said at least one other wireless device, and wherein said determining determines that a signal strength of said received signals deviates from an expected signal strength.

44. A wireless network, comprising:
a first wireless communications device coupled to said wireless network;
at least one other wireless communications device coupled to said wireless network, and wherein said at least one other wireless communications device comprises
a measurement sub-system for measuring characteristics of signals received at said at least one other wireless device;
a processing sub-system for determining that a characteristic of said received signal deviates from an expected characteristic of said received signal; and
a security sub-system for evaluating a connection between said first wireless device and said wireless network to determine that said connection is undesirable in conformity with said determination by said processing subsystem.

45. The wireless network of claim 44, wherein said at least one other wireless device transmits a distance measuring signal to said first wireless device, wherein said receiving receives a response from said first wireless device to said distance measuring signal, and wherein said processing subsystem determines that a communications time delay between said transmitting and said receiving deviates from an expected time delay.

46. The wireless network of claim 44, wherein said at least one other wireless device receives signals from said first wireless device at said at least one other wireless device, and wherein said processing subsystem determines that a signal strength of said received signals deviates from an expected signal strength.
